(19) United States
(12) Patent Application Publication
(10) Pub. No.: US 2004/0238362 A1
(43) Pub. Date: Dec. 2, 2004

(54) Cured multilayer coating providing improved edge corrosion to a substrate and a method of making same

(76) Inventor: Timothy S. December, Rochester, MI (US)

Correspondence Address: BASF CORPORATION, ANNE GERRY SABOURIN, 26701 TELEGRAPH ROAD, SOUTHFIELD, MI, 48034-2442, US

(21) Appl. No.: 10/878,793

(22) Filed: Jun. 28, 2004

Related U.S. Application Data
(63) Continuation-in-part of application No. 09/998,455, filed on Nov. 29, 2001.
Application No. 09/998,455 is a continuation-in-part of application No. 09/464,432, filed on Dec. 15, 1999, now Pat. No. 6,342,144.
Application No. 09/998,455 is a continuation-in-part of application No. 09/907,206, filed on Jul. 17, 2001.

(51) Int. Cl. G01L 1/20; B01D 59/42; C23C 28/00

(52) U.S. Cl. 204/492; 204/501

(57) ABSTRACT

A cured multilayer coating provides improved edge corrosion resistance to a substrate. The method of making the cured multilayer coating includes applying by electrophoretic deposition a first curable coating composition to the substrate to establish a coated substrate. The coated substrate is then subjected to an amount of energy sufficient to cause the coated substrate to become a conductive coated substrate. Next, a second curable coating composition is applied to the conductive coated substrate to establish a multicoated substrate. The multicoated substrate is then subjected to an amount of energy sufficient for cross-linking the first and second curable coating compositions to make the cured multilayer coating. The cured multilayer coating has less than 40 rust spots as measured by an Edge Corrosion Test, while a surface roughness, Ra, of the cured multilayer coating is maintained at or below 13 μin (4.29 nm).

### CROSS-REFERENCE TO RELATED APPLICATIONS

This is a continuation-in-part of U.S. patent application Ser. No. 09/998,455, filed on Nov. 29, 2001, which is a continuation-in-part of U.S. patent application Ser. Nos.

i) 09/464,432, filed on Dec. 15, 1999, now U.S. Pat. No. 6,342,144, issued Jan. 29, 2002, and

ii) Ser. No. 09/907,206 filed on Jul. 17, 2001, pending,

all of which are incorporated herein by reference.

### BACKGROUND OF THE INVENTION

Automotive manufacturers traditionally rely on electrophoretically deposited coating compositions, both cathodic and anodic, for significant protection against corrosion, e.g. rusting, of a conductive substrate, such as an automotive body. Resistance to corrosion is especially critical at edges of the substrate where corrosion of the substrate often begins and thereafter further propagates across the entire substrate. For descriptive purposes, use of the terminology “electrocoat” may refer to the curable coating compositions used in electrophoretic deposition and also to the cured coatings obtained from curing of the curable coating compositions applied by electrophoretic deposition.

During electrophoretic deposition, i.e., electrodeposition, an ionically-charged resin having a relatively low molecular weight is deposited onto the substrate by immersing the substrate in an electrocoat bath including the resin dispersed therein. An electrical potential is applied between the substrate and a pole of opposite charge, usually a stainless steel electrode. This produces a relatively soft coating of the resin on the substrate. This coating is converted into a relatively hard coating, having increased molecular weight, by cross-linking the resin, typically upon exposure to elevated temperatures.

When the coating deposited on the substrate is subjected to elevated temperatures, a viscosity of the coating decreases before the coating is ‘set’ or cured. Furthermore, when the viscosity of the coating decreases, the coating flows away from the edges of the substrate leaving the edges exposed. When the edges of the substrate are exposed, the entire substrate is susceptible to corrosion upon prolonged exposure to environmental elements.

In an effort to optimize edge corrosion resistance of automotive bodies, the automotive manufacturers have placed increased emphasis on electrocoats that provide improved resistance to edge corrosion by more effectively covering edges. In other words, there is a demand throughout the industry to provide electrocoats that do not flow away from the edges of the substrate prior to cure. The automotive manufactures have additionally demanded that these electrocoats do not sacrifice appearance, i.e., surface roughness, while achieving the improved resistance to edge corrosion.

The electrocoats of the prior art have long attempted to provide improved resistance to edge corrosion. However, for various reasons, the prior art attempts to provide improved resistance to edge corrosion are deficient. For instance, it is already recognized that resistance to edge corrosion can be improved by the inclusion of flow control additives. Flow control additives ensure that the viscosity of the coating does not decrease, and consequently that the coating does not flow away from edges, prior to cure of the coating. To eliminate or sufficiently minimize any decrease in viscosity, these flow control additives generally cause ‘tightening’ of the coating, and as a result, the surface roughness of the coating increases drastically. Ultimately, the appearance of the coating is sacrificed.

U.S. Pat. No. 6,207,731 to Gam exemplifies the deficiencies associated with the inclusion of flow control additives. The '731 patent requires a flow control additive to provide improved edge coverage. As described above, the flow control additive causes the surface roughness of the various electrocoats disclosed in the '731 patent to increase. More specifically, when an Edge Corrosion Test is performed with the electrocoats disclosed in the '731 patent, the surface roughness of the electrocoat is 22 μin (7.36 nm) when there are zero “rust spots” on a blade, i.e., an edge (refer to Column 7, lines 33-51). Generally, surface roughness measurements that exceed 15 μin (4.99 nm) are unacceptable in the automotive manufacturing industry. Although the various electrocoats disclosed in the '731 patent do disclose surface roughness measurements less than 15 μin (4.99 nm), these particular electrocoats result in from 60 to 140 rust spots on the blades, which is also unacceptable in the automotive manufacturing industry. The Edge Corrosion Test is generally accepted and used throughout the automotive manufacturing industry to measure edge corrosion resistance. Beside the inclusion of the flow control additive, the '731 patent is also deficient because it does not recognize the ability to apply multiple coatings to the substrate which improves edge coverage, thereby improving edge corrosion resistance, and which maintains surface roughness.

It is generally understood that when multiple coatings are electrodeposited on the substrate, the first, or underlying, coating can become electrically insulative which interferes with the subsequent electrodeposition of the second coating and prevents suitable film build of the second coating. Lack of suitable film build leads to exposed edges, and therefore increased edge corrosion, on the substrate. Therefore, these electrocoats incorporate an electrically conductive additive to achieve suitable film build such that the edges are sufficiently covered to improve edge corrosion resistance.

U.S. Pat. No. 5,275,707 to Yamada et al. discloses multiple coatings that are electrodeposited on a substrate. These coatings incorporate an electrically conductive additive. More specifically, to achieve the suitable film build, the various electrocoats disclosed in the '707 patent require a relatively specific and complex, electrically semiconductive substance such as molybdenum disulfide, as opposed to electroconductive carbon black. Because the electrically semiconductive substances disclosed in the '707 patent are complex, they are not standard and are frequently costly. In fact, even when the various electrocoats disclosed in the '707 patent include electroconductive carbon black as the electrically semiconductive substance, they are not able to achieve suitable edge corrosion resistance (refer to Comparative Examples 1 and 2). Also, the surface roughness of the electrocoats that include the electroconductive carbon black “rough” which is not acceptable.

Because, as set forth above, the various electrocoats of the prior art are deficient, it is desirable to provide a method of making a cured multilayer coating that provides improved edge corrosion resistance to a substrate while maintaining acceptable surface roughness, i.e., excellent appearance. It is also an object of the subject invention to provide a cured multilayer coating that is made according to the method above.

### SUMMARY OF THE INVENTION

A method of making a cured multilayer coating comprising

(A) applying by electrophoretic deposition a first curable coating composition to the substrate thereby establishing a coated substrate, the first curable coating composition comprising;

(i) a first compound comprising one or more active hydrogen-containing groups,

(ii) a first curing agent comprising one or more functional groups reactive with the active hydrogen-containing groups of the first compound, and

(iii) an electroconductive additive,

(B) subjecting the coated substrate to an amount of energy sufficient to cause the coated substrate to become a conductive coated substrate having an electrical conductivity of at least 130 S/cm due to the electroconductive additive, but not fully curing the coated substrate;

(C) applying a second curable coating composition to the conductive coated substrate thereby establishing a multicoated substrate, the second curable coating composition comprising;

(i) a second compound comprising one or more active hydrogen-containing groups, and

(ii) a second curing agent comprising one or more functional groups reactive with the active hydrogen-containing groups of the second compound, and

(D) subjecting the multicoated substrate to an amount of energy sufficient for cross-linking the first and second curable coating compositions to make the cured multilayer coating that provides the improved edge corrosion resistance to the substrate,

wherein a surface roughness of the cured multilayer coating is maintained at or below 13 μin, and, in an Edge Corrosion Test, the cured multilayer coating has less than 40 rust spots, wherein the Edge Corrosion Test comprises

(a) providing a knife blade measuring 2 cm×10 cm,

(b) applying the first curable coating composition on the knife blade at a thickness of about 17 μm,

(c) curing the first curable coating composition at 350° F. (176.7° C.) for 30 minutes,

(d) applying the second curable coating composition to the cured first coating composition at a thickness of about 15 μm,

(e) curing the second curable coating composition at 350° F. (176.7° C.) for 30 minutes,

(f) subjecting the knife blade to a Salt Spray Test per ASTM B117-94 for 10 days, and

(g) counting the number of rust spots on the edge of the knife blade.

### DETAILED DESCRIPTION OF THE PREFERRED EMBODIMENT

As used throughout, ranges are used as a shorthand for describing each and every value that is within the range. Any value within the range can be selected as the terminus of the range. When used, the phrase “at least one of” refers to the selection of any one member individually or any combination of the members. The conjunction “and” or “or” can be used in the list of members, but the “at least one of” phrase is the controlling language. For example, at least one of A, B, and C is shorthand for A alone, B alone, C alone, A and B, B and C, A and C, or A and B and C.

A method of making a cured multilayer coating is disclosed. The cured multilayer coating made according to the method of the subject invention provides an improved edge corrosion resistance to a substrate, as measured according to an Edge Corrosion Test. The substrate is conductive. The improved edge corrosion resistance and the Edge Corrosion Test are described in detail below. Preferably, an automotive body panel is provided as the substrate.

To make the cured multilayer coating, a first curable coating composition is applied, by electrophoretic deposition, to the substrate. Upon application, a coated substrate is established. The first curable coating composition includes a first compound, a first curing agent, and an electroconductive additive. More specifically, the first compound includes one or more active hydrogen-containing groups, and the first curing agent comprises one or more functional groups reactive with the active hydrogen-containing groups of the first compound.

It is to be understood that cured coatings or cured coating layers that are applied by electrophoretic deposition are referred to as electrocoats or “E-coats” and are typically used as a first applied primer coating layer for protecting the substrate from corrosion such as rusting. Also, for descriptive purposes, the terminology electrocoat may also refer to the curable coating compositions included in the subject invention. As stated above, the first curable coating composition is electrophoretically deposited to the substrate. Suitable first curable coating compositions may be either an anodic or a cathodic electrocoat coating composition.

The first curable coating composition comprises the first compound comprising the one or more active hydrogen-containing groups and at least one or more ionic groups or groups convertible to ionic groups. The ionic groups or groups which can be converted to ionic groups may be anionic groups or groups which can be converted into anionic groups, e.g. acidic groups such as —COOH groups, or cationic groups or groups which can be converted into cationic groups, e.g. basic groups such as amino groups and ammonium groups such as quaternary ammonium groups, or phosphonium and/or sulphonium groups. Basic groups which contain nitrogen are particularly preferred. These groups may be present in quaternised form, or are at least partially converted into ionic groups with a customary nuetralizing agent such as an acid, e.g. an organic monocarboxylic acid, such as formic acid or acetic acid for example.

Examples of suitable first compounds for use in the anodic electrocoat coating compositions, hereinafter referred to as anodic first compounds, include resins which are based on polyesters, acrylics, vinyl, epoxy, polyurethane, alkyds, mixtures thereof, and the like. Thus, the one or more active hydrogen-containing groups in the anodic first compounds may generally be selected from the groups consisting of carboxylic acid, hydroxyl, carbamate, isocyanate, amine, epoxy, acrylate, vinyl, acetoacetate, mixtures thereof, and the like, with hydroxyl, carbamate and mixtures thereof being preferred and hydroxyl, primary carbamate and mixtures thereof being most preferred.

Illustrative examples of suitable anodic first compounds will have a weight average molecular weight in the range of about 300 to 100,00, preferably from 10,000 to 60,000. Weight average molecular weight can be determined by the GPC method using a polystyrene standard. These suitable anodic first compounds may also be characterized by an acid number in the range of 20 to 300 mg KOH/g for example, preferably from 20 to 80, most preferably from 30 to 50.

The anodic first compounds typically comprise one or more, preferably a plurality of, ionic groups which are acidic, such as —COOH, —SO₃H and/or PO₃H₂ groups, with —COOH groups being most preferred. The anodic first compounds can be converted into the aqueous phase after neutralization of at least part of the acidic groups. Neutralization preferably occurs with amines, especially tertiary amines or alkanol amines and most preferably with teritary alkanol amines such as dimethyl ethanolamine.

Preferred anodic first compounds are those that are obtained through the copolymerization of one or more monomers selected from the group consisting of alkyl and hydroxy alkyl esters of unsaturated organic acids, ethylencially unsaturated monomers, unsaturated organic acids and mixtures thereof. Examples of suitable alkyl and hydroxy alkyl esters of (meth)acrylic acid include ethyl acrylate, butyl acrylate, 2-ethylhexyl acrylate, butyl methyacrylate, isodecyl methyacrylate, hydroxyethyl methacrylate, hydroxypropyl methacrylate, and the like. Examples of suitable ethylenically unsaturated monomers include unsaturated m-tetramethyl xylene isocyanate (sold by American Cyanamid as TMI®), styrene, vinyl toluene, alpha methyl styrene and the like. Examples of suitable unsaturated organic acids include acrylic acid, methacrylic acid, crotoic acid, vinylacetate acid, tiglic acid, 3,3-dimethylacrylic acid, trans-2-pentenoic acid, 4-pentenoic acid, trans-2-methyl-2-pentenoic acid, 6-heptanoic acid, 2-octenoic acid, and the like. Preferred unsaturated organic acids include acrylic acid, methacrylic acid, and mixtures thereof.

A most preferred anodic first compound disclosed in pending U.S. patent application Ser. No. 09/217,557, entitled “Anodic Electrocoat Having a Carbamate Functional Resin”, all of which is hereby incorporated by reference. Such an anodic first compound has at least one carbamate functional group appended to a polymer backbone, preferably a plurality of pendant carbamate functional groups.

Illustrative examples of the most preferred anodic first compounds suitable for use in the instant invention can be prepared in a variety of ways. One way to prepare such these compounds is to prepare an acrylic monomer having a carbamate functionality in the ester portion of the monomer. Such monomers are well-known in the art and are described, for example in U.S. Pat. Nos. 3,479,328; 3,674,838; 4,126,747; 4,279,833; and 4,340,497; the disclosures of which are incorporated herein by reference. One method of synthesis involves reaction of a hydroxy ester with urea to form the carbamyloxy carboxylate (i.e., carbamate-modified acrylic). Another method of synthesis reacts an α, β-unsaturated acid ester with a hydroxy carbamate ester to form the carbamyloxy carboxylate. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid to form the monomer. Other methods of preparing carbamate-modified acrylic monomers are described in the art, and can be utilized as well. The acrylic monomer can then be polymerized along with other ethylenically-unsaturated monomers, if desired, by techniques well-known in the art. However, such ethylenically unsaturated monomers must comprise at least one monomer having a pendant carboxylic acid group.

For example, preferred methods of preparing illustrative examples of the anodic first compound most preferred for use in the instant invention include the following: One or more carbamate functional monomers such as 2-carbamate ethyl methyacrylate (CEMA) may be copolymerized with two or more monomers such as an unsaturated organic acid and a alkyl ester of an unsaturated organic acid in the presence of a suitable initiator such as an azo or peroxide initiator. Other suitable carbamate functional monomers include those described above. Suitable unsaturated organic acids will be of the formulas R¹R²═R³COOH or R¹R²═R³R⁴COOH, where R¹, R², R³, and R⁴ may be the same or different and are selected from the group consisting of H, alkyl groups of from 2 to 12 carbons, and mixtures thereof. Examples of suitable unsaturated organic acids include acrylic acid, methacrylic acid, crotoic acid, vinylacetate acid, tiglic acid, 3,3-dimethylacrylic acid, trans-2-pentenoic acid, 4-pentenoic acid, trans-2-methyl-2-pentenoic acid, 6-heptanoic acid, 2-octenoic acid, and the like. Preferred unsaturated organic acids include acrylic acid, methacrylic acid, and mixtures thereof. Examples of suitable alkyl esters of unsaturated organic acid include ethyl acrylate, butyl acrylate, 2-ethylhexyl acrylate, butyl methyacrylate, isodecyl methyacrylate, hydroxyethyl methacrylate, hydroxypropyl methacrylate, and the like. Preferred alkyl esters are nonhydroxy functional esters such as butyl acrylate and butylmethacrylate. Other ethylenically unsaturated monomers such as styrene may be also used.

In another reaction scheme, an isocyanate functional monomer such as unsaturated m-tetramethyl xylene isocyanate (sold by American Cyanamid as TMI®) can be copolymerized with monomers such as alkyl esters, such as described immediately above, and unsaturated monomers, such as styrene, to produce an isocyanate functional polymer. The required carboxylic acid functionality and carbamate functionality can then be grafted onto the isocyanate functional polymer by a two-stage reaction having a first stage using a carbamate functional monomer such as hydroxypropyl carbamate followed by a second stage using a carboxylic acid of the formula HO—(R)—COOH or an amine salt of the formula HO—(R)—COOH⁺NR₃, wherein R is an alkyl group of from 1 to 12 carbons, preferably from 2 to 8 carbons.

Alternatively, one or more carbamate functional monomers may be reacted with an isocyanate functional monomer such as an unsaturated m-tetramethyl xylene isocyanate to produce a carbamate functional monomer. Additional isocyanate monomer may be added to introduce isocyanate functionality in the monomer mixture. After polymerizing the one or more monomers, the required pendant carboxylic acid functionality can be grafted onto the polymer backbone using a carboxylic acid functional compound having at least one group reactive with an isocyanate, such as a hydroxy carboxylic acid.

Alternatively, carbamate functional adducts made from polyisocyanate functional compounds such as IPDI or TDI and hydroxy carbamate compounds can be made and then grafted onto acrylic, epoxy or other hydroxy functional polymers having acid numbers of at least 20, preferably 30. Of course, it will be appreciated that such resins must have the characteristics required for in electrocoat compositions as discussed herein. Preferred polymers for use as the backbone of most preferred anodic compound (a) are hydroxyl functional acrylic resins with acid numbers of at least 20, preferably at least 30.

A most preferred method of making the most preferred anodic first compound suitable for use in the instant invention involves the copolymerization of at least one carbamate functional monomer, at least one unsaturated organic acid, at least one alkyl ester of an unsaturated organic acid and at least one additional ethylenically unsaturated monomer such as styrene. A most preferred reaction scheme involves the copolymerization of CEMA, acrylic acid, styrene and butyl acrylate in the presence of an azo or peroxide initiator.

The most preferred anodic first compound can be represented by the randomly repeating units according to the following formula:

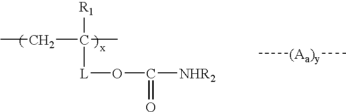

In the above formula, R₁ represents H or CH₃. R₂ represents H, alkyl, preferably of 1 to 6 carbon atoms, or cycloalkyl, preferably up to 6 ring carbon atoms. It is to be understood that the terms alkyl and cycloalkyl are to include substituted alkyl and cycloalkyl, such as halogen-substituted alkyl or cycloalkyl. Substituents that will have an adverse impact on the properties of the cured material, however, are to be avoided. For example, ether linkages are thought to be susceptible to hydrolysis, and should be avoided in locations that would place the ether linkage in the crosslink matrix. The values x and y represent weight percentages, with x being 10 to 90% and preferably 40 to 60%, and y being 90 to 10% and preferably 60 to 40%.

In the formula, Aₐ represents repeat units derived from one or more ethylenically unsaturated monomers, at least one of which repeat units must have a pendant carboxylic acid group. The at least one carboxylic acid group may derive from the use of at least one ethylenically unsaturated monomer having at least one carboxylic acid group, preferably a pendant or terminal carboxylic acid group. Alternatively, the at least one repeating unit having a pendant carboxylic acid may derive from the graft of a free organic acid to the polymer backbone of the repeating units (A), as discussed above, wherein such free organic acid has a functional group reactive with the backbone polymer.

Examples of ethylenically unsaturated monomers having a pendant carboxylic acid group include acrylic acid, methacrylic acid, crotoic acid, vinylacetate acid, tiglic acid, 3,3-dimethylacrylic acid, trans-2-pentenoic acid, 4-pentenoic acid, trans-2-methyl-2-pentenoic acid, 6-heptanoic acid, 2-octenoic acid, and the like. Preferred ethylenically unsaturated monomers having a pendant carboxylic acid are acrylic acid, methacrylic acid and mixtures thereof.

Examples of free organic acids which may be used to graft a pendant carboxylic acid group to the backbone polymer include compounds of the formula HO—(R)—COOH or an amine salt of the formula HO—(R)—COOH⁺NR₃, wherein R is an alkyl group of from 1 to 12 carbons, preferably from 2 to 8 carbons. Polyacids such as malic acid and citric acid may also be used. Preferred organic free acids are lactic acid, glycolic acid and stearic acid.

Other monomers which may be utilized to provide repeating units (Aₐ) of the anodic first compound not having pendant carboxylic acid functionality are those monomers for copolymerization with acrylic monomers known in the art and discussed above. These include alkyl esters of acrylic or methacrylic acid, e.g., ethyl acrylate, butyl acrylate, 2-ethylhexyl acrylate, butyl methacrylate, isodecyl methacrylate, hydroxyethyl methacrylate, hydroxypropyl acrylate, and the like; and vinyl monomers such as unsaturated m-tetramethyl xylene isocyanate (sold by American Cyanamid as TMI®), styrene, vinyl toluene and the like.

L represents a divalent linking group, preferably an aliphatic of 1 to 8 carbon atoms, cycloaliphatic, or aromatic linking group of 6 to 10 carbon atoms. Examples of L include

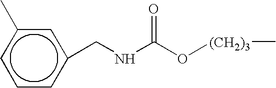

—(CH₂)—, —(CH₂)₂—, —(CH₂)₄—, and the like. In one preferred embodiment, -L- is represented by —COO-L′- where L′ is a divalent linking group. Thus, in a preferred embodiment of the invention, the anodic first compound may be represented by randomly repeating units according to the following formula:

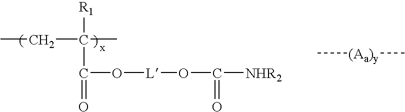

In this formula for the most preferred anodic first compound, R₁, R₂, A, x, and y are as defined above. L′ may be a divalent aliphatic linking group, preferably of 1 to 8 carbon atoms, e.g., —(CH₂)—, —(CH₂)₂—, —(CH₂)₄—, and the like, or a divalent cycloaliphatic linking group, preferably up to 8 carbon atoms, e.g., cyclohexyl, and the like. However, other divalent linking groups can be used, depending on the technique used to prepare the polymer. For example, if a hydroxyalkyl carbamate is adducted onto an isocyanate-functional acrylic polymer, the linking group L′ would include an —NHCOO— urethane linkage as a residue of the isocyanate group. Of course, Aₐ would still require the necessary pendant carboxylic acid groups as discussed above.

The most preferred anodic first compound may be further characterized by an acid number of from 20 to 80, preferably an acid number of from 30 to 50 and most preferably an acid number of from 30 to 35.

The most preferred anodic first compound should also have a carbamate equivalent weight (grams of the anodic first compound/equivalent of carbamate) of from 150 to 1200, preferably from 200 to 600, and most preferably from 300 to 400.

Despite that described above, the most preferred first curable coating composition is the cathodic electrocoat coating composition.

Examples of suitable first compounds for use in the cathodic electrocoat coating compositions, hereinafter referred to as cationic first compounds, include resins which are based on epoxy and bisphenol A and have one or more primary, secondary, tertiary, or quaternary ammonium groups. Illustrative examples of suitable cationic first compounds generally have amine numbers in the range of 0.1 to 1.0 meq. The weight average molecular weight (Mw) of such cationic first compounds is from 300 to 100,000, preferably from 10,000 to 60,000.

More specifically, examples of suitable cationic first compounds include, without a limitation, polymers and resins such as acrylic, epoxy, polyurethane, alkyd, carbamate, polyesters, vinyl, alkyds, mixtures thereof, and the like. Thus the one or more active hydrogen groups for suitable cationic first compounds may generally be selected from the groups consisting of carboxylic acid, hydroxyl, carbamate, isocyanate, amine, epoxy, acrylate, vinyl, acetoacetate, mixtures thereof and the like, with hydroxyl, carbamate and mixtures thereof being preferred and hydroxyl, primary carbamate and mixtures thereof being more preferred.

Preferred cationic first compounds includes those containing at least one carbamate functional group and one or more repeat units having at least one pendent cationic salting site. Examples of suitable carbamate functional resins for use in cationic electrocoat compositions are described in pending U.S. patent application Ser. No. 09/217,917, entitled “Cathodic Electrocoat Having a Carbamate Functional Resin”, all of which is hereby incorporated by reference.

Preferred cationic first compounds of the subject invention have at least one carbamate functional group appended to a polymer backbone, more preferably a plurality of pendant carbamate functional groups. It is preferred, but not necessary, that the polymer backbone to which the carbamate functional group is appended be an acrylic polymer.

The preferred cationic first compound can be prepared in a variety of ways. One way to prepare the cationic first compounds is to prepare an acrylic monomer having carbamate functionality in the ester portion of the monomer. Such monomers are well known in the art and are described, for example in U.S. Pat. Nos. 3,479,328; 3,674,838; 4,126,747; 4,279,833; and 4,340,497; the disclosures of which are incorporated herein by reference. One method of synthesis involves reaction of a hydroxy ester with urea to form the carbamyloxy carboxylate (i.e., carbamate-modified acrylic). Another method of synthesis reacts an α,β-unsaturated acid ester with a hydroxy carbamate ester to form the carbamyloxy carboxylate. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid to form the monomer. Other methods of preparing carbamate-modified acrylic monomers are described in the art, and can be utilized as well. The acrylic monomer can then be polymerized along with other ethylenically-unsaturated monomers, if desired, by techniques well-known in the art. In a preferred embodiment, at least one of the ethylenically unsaturated monomers will have a pendant cationic salting group.

As used herein, the term “cationic salting site” refers to a functional group which is sufficiently basic to undergo reaction with an acid to produce a salt, which, while in an aqueous dispersion in the presence of a voltage, will undergo decomposition and facilitate the formation of a insoluble polymer which deposits on a substrate immersed in the aqueous dispersion. Preferred cationic salting groups are amine functional groups and quaternary ammonium salts. The amine functional groups of the cationic first compound may be primary, secondary, tertiary amino groups or quaternary ammonium salts. Quaternary ammonium salts and tertiary amines are most preferred, with quaternary ammonium salts especially preferred. Such groups may also be part of polyamines and/or alkanol amines.

The cationic salting site can be incorporated into or grafted to the polymer backbone of the cationic first compound in a variety of ways.

For example, a carbamate functional acrylic monomer can be copolymerized with an ethylenically unsaturated monomer having at least one cationic salting group. The cationic salting group may be a primary, secondary, or tertiary amine functional group, or a quaternary ammonium salt, or a mixture thereof. Illustrative examples of such monomers are methacrylamide, acrylamide, dimethylaminoethyl methyacrylate, mixtures thereof, and the like. Another example of a suitable ethylenically unsaturated monomer having amino functionality is the reaction product of glycidyl methacrylate and a tertiary amine salt. Dimethylaminoethyl methacrylate is preferred.

Alternatively, as will be discussed below, a polymer having oxirane or glycidyl functionality can be made and the cationic salting group formed by reaction of the glycidyl group with an amine or a polyamine. Amines or polyamines may be used having primary, secondary, or tertiary amine groups. Tertiary amine salts may be used to form quaternary ammonium salts via reaction with the glycidyl group on the polymer backbone and are preferred.

Finally, a monomer such as glycidyl methacrylate can be polymerized with a ethylenically unsaturated carbamate functional monomer to produce a carbamate functional acrylic having pendent glycidyl functionality. A cationic salting site can be incorporated by reaction of an amine functional compound, polyamine, or tertiary amine salt with the oxirane group.

Preferred methods of preparing the cationic first compound having an acrylic backbone include the following:

One or more carbamate functional monomers such as 2-carbamate ethyl methyacrylate (CEMA) may be copolymerized with at least one ethylenically unsaturated amine functional compound, at least one alkyl ester of an unsaturated organic acid and at least one other ethylenically unsaturated monomer such as styrene in the presence of a suitable initiator such as an azo or peroxide initiator. Other suitable carbamate functional monomers include those discussed above. Illustrative suitable unsaturated amine functional compounds are as discussed above. A preferred unsaturated amine functional compound is dimethylaminoethyl methyacrylate. Examples of suitable alkyl esters of unsaturated organic acid include ethyl acrylate, butyl acrylate, 2-ethylhexyl acrylate, butyl methyacrylate, isodecyl methyacrylate, hydroxyethyl methacrylate, hydroxypropyl methacrylate, and the like. Preferred alkyl esters are nonhydroxy functional monomers such as butyl acrylate and butylmethacrylate. A preferred monomer for use as an additional ethylenically unsaturated monomer is styrene.

In another reaction scheme, an adduct may be made from a polyisocyanate such as isophorone diisocyanate (IPDI) or toluene diisocyanate (TDI) and a hydroxy functional carbamate compound such as hydroxypropyl carbamate. The resulting adduct can then be grafted onto an acrylic, epoxy or other hydroxy functional resin having suitable characteristics for use.

Another method involves a multistep reaction wherein a hydroxy carbonate may reacted with ammonia or an amine functional compound to provide a primary, secondary or tertiary carbamate functional compound. This compound is then reacted with an anhydride compound via the reaction of the hydroxy group with the anhydride ring. The carboxylic acid groups of the resulting reaction product are then reacted with the oxirane groups of a glycidyl ether of Bisphenol A. Cationic salting groups are incorporated via the reaction of an amine functional compound, such as diethanol amine, with the glycidyl ether groups which terminate the resulting hydroxy and carbamate functional polymer.

In an alternative reaction, an isocyanate functional monomer such as unsaturated m-tetramethyl xylene isocyanate (sold by American Cyanamid as TMI®) can be copolymerized with monomers such as alkyl esters such as described immediately above such as butyl acrylate and unsaturated monomers such as styrene to produce an isocyanate functional polymer. The required cationic salting group functionality and carbamate functionality can then be grafted onto the isocyanate functional polymer by a multi-stage reaction having a first stage using a carbamate functional monomer such as hydroxypropyl carbamate followed by a second stage using an amine functional compound, i.e., primary, secondary or tertiary amine groups, most preferably an alkanol amine.

In general, the preferred cationic first compound can be represented by the randomly repeating units according to the following formula:

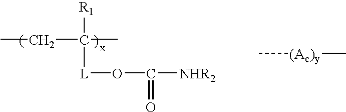

In the above formula, R₁ represents H or CH₃. R₂ represents H, alkyl, preferably of 1 to 6 carbon atoms, or cycloalkyl, preferably up to 6 ring carbon atoms. It is to be understood that the terms alkyl and cycloalkyl are to include substituted alkyl and cycloalkyl, such as halogen-substituted alkyl or cycloalkyl. Substituents that will have an adverse impact on the properties of the cured material, however, are to be avoided. For example, ether linkages are thought to be susceptible to hydrolysis, and should be avoided in locations that would place the ether linkage in the crosslink matrix. The values x and y represent weight percentages, with x being 10 to 90 % and preferably 40 to 60%, and y being 90 to 10% and preferably 60 to 40%.

In the formula, Ac represents comprises one or more repeat unit having a pendent cationic salting site. Such repeat units may be derived from one or more ethylenically unsaturated monomers, at least one of which repeat units must have a pendent cationic salting group, preferably an amino group.

The at least one cationic salting group may derive from the use of at least one ethylenically unsaturated monomer having at least one amino group. Alternatively, the at least one repeating unit having a pendent cationic salting site may derive from the reaction of an amine functional compound with a glycidyl group previously incorporated into the polymer.

L represents a divalent linking group and is the same as discussed above with respect to the anodic first compound.

In an especially preferred embodiment, the cationic first compound comprises a polymer, A, which may be made via the grafting of a carbamate functional intermediate adduct onto an acrylic, epoxy, or other hydroxy functional resin having suitable characteristics for use as discussed below. In a preferred reaction scheme, the carbamate functional intermediate adduct may be made from the reaction of a polyisocyanate and a carbamate functional compound comprising at least one group which is reactive with the polyisocyanate. Preferably, the compound comprises at least one primary carbamate group.

Suitable polyisocyanates are monomeric polyisocyanates that can be aliphatic, cycloaliphatic, and/or aromatic polyisocyanates. Useful aliphatic polyisocyanates include aliphatic diisocyanates such as ethylene diisocyanate, 1,2-diisocyanatopropane, 1,3-diisocyanatopropane, 1,6-diisocyanatohexane, 1,4-butylene diisocyanate, lysine diisocyanate, 1,4-methylene bis-(cyclohexyl isocyanate) and isophorone diisocyanate. Useful aromatic diisocyanates and araliphatic diisocyanates include the various isomers of toluene diisocyanate, meta-xylylenediioscyanate and para-xylylenediisocyanate, also 4-chloro-1,3-phenylene diisocyanate, 1,5-tetrahydro-naphthalene diisocyanate, 4,4′-dibenzyl diisocyanate and 1,2,4-benzene triisocyanate can be used. In addition, the various isomers of α,α,α′,α′-tetramethyl xylene diisocyanate can be used. Biurets of isocyanates such as DESMODUR® N100 from Bayer may also be useful. Preferably, the polyisocyanate is a diisocyanate. Isophorone diisocyanate is most preferred.

Suitable examples of such isocyanate reactive, carbamate functional compounds are commercially available hydroxy functional carbamate compounds such as hydroxypropyl carbamate, hydroxybutyl carbamate, and mixtures thereof. Hydroxypropyl carbamate is preferred. It is also within the scope of the invention to use isocyanate reactive compounds containing groups convertible to carbamate in place of the isocyanate reactive, carbamate functional compounds. Use of the term “convertible to carbamate” refers to groups which have the capability of forming carbamate groups, preferably primary carbamate groups after reaction with the polyisocyanate is completed. Examples of groups convertible to carbamate include cyclic carbonate groups, (i.e., the reaction product of glycidol and CO₂ then reacted with ammonia to form a carbamate group), and epoxy groups (i.e., reaction of the epoxy with CO₂ to form cyclic carbonate followed by reaction with ammonia).

The isocyanate reactive, carbamate functional compound is reacted with the polyisocyanate to provide an intermediate compound having at least one carbamate group, preferably at least one primary carbamate group, and at least one isocyanate group.

In a particularly preferred embodiment, the isocyanate reactive carbamate functional compound will be reacted with the polyisocyanate under reaction conditions sufficient to produce both the intermediate compound having both carbamate functionality and isocyanate functionality as well as a carbamate functional reactive additive which is free of isocyanate functionality. In this embodiment, both the intermediate compound and the carbamate functional reactive additive are the reaction products of a single reaction. Accordingly, the carbamate functional reactive additive may be described as being generated “in situ” during the production of the intermediate compound. Examples of suitable reaction conditions include a mole equivalent ratio of NCO to hydroxyl of from 2/1 to 2/2, preferably from 1.2 to 1.8, and most preferably from 1.3 to 1.7. Other reaction conditions to consider include temperature and catalyst type and level. However, it is to be appreciated that the in situ carbamate functional reactive additive is an optional element with respect to the instant invention.

The in situ carbamate functional reactive additive has a number average molecular weight of from 250 to 2000 and most preferably from 400 to 800. Preferably, the in situ carbamate functional reactive additive has a degree of carbamate functionality equal to the degree of isocyanate functionality of the polyisocyanate, i.e., the polyisocyanate will preferably be diblocked for the in situ carbamate reactive additive when the polyisocyanate is a diisocyanate.

The carbamate functional/isocyanate functional intermediate compound is then grafted onto an acrylic, epoxy or other hydroxy functional resin having suitable characteristics for use to form the preferred embodiment of the cationic first compound. The grafting of the intermediate compound must occur via reaction with the at least one isocyanate group of the intermediate compound with a reactive group of the acrylic, epoxy or other hydroxy functional resin.

Most preferably, the carbamate functional/isocyanate functional intermediate compound is grafted onto a hydroxy functional resin comprising epoxy groups. The grafting of the intermediate compound will thus occur via reaction between a hydroxyl group and the at least one isocyanate group of the intermediate compound. Preferably, the hydroxy functional resin comprising epoxy groups will be an epoxy functional resin. As discussed below, reaction of the epoxy group with a tertiary amine in the presence of an acid is a preferred method of incorporating the most preferred one or more quaternary ammonium groups.

Suitable epoxy containing polymers are resinous polyepoxide or polymeric resinous materials containing two or more 1,2-epoxy groups per molecule. Preferred polyepoxides are polyglycidyl ethers of polyhydric phenols such as bisphenol A. These can be produced by etherification of a polyphenol with an epihalohydrin or dihalohydrin such as epichlorohydrin or dichlorohydrin in the presence of alkali. Suitable polyhydric phenols include bis-2,2-(4-hydroxyphenyl)propane, bis-1,1-(4-hydroxyphenyl)ethane, bis(2-hydroxynaphthyl)methane and the like.

Other useful polyepoxide compounds are those made from novolac resins or similar polyhydroxyphenol resins.

Also suitable are polyglycidyl ethers of polyhydric alcohols such as ethylene glycol, propylene glycol, diethylene glycol and triethylene glycol.

There can also be used polyglycidyl esters of polycarboxylic acids which are produced by the reaction of epichlorohydrin or a similar epoxy compound with an aliphatic or aromatic polycarboxylic acid such as succinic acid and terepthalic acid.

Most preferably, the epoxy-containing compound to which the carbamate functional intermediate is grafted onto will be the reaction product of a liquid epoxy such as diglycidyl ether of bisophenol A (DGEBA) and bisphenol A. Particularly preferred examples of such epoxy containing compounds may be characterized as upgraded epoxy resins having epoxy equivalent weights of approximately 1100. Suitable liquid epoxys are GY2600, commercially available from Ciba Geigy and Epon® 828, commercially available from Shell Chemical Company.

Thus, the preferred cationic first compound comprises the polymer, A, and optional carbamate functional reactive additive generated during the production of the polymer, A, more specifically during the production of the intermediate compound. The carbamate functional reactive additive will be present in the resin composition of the invention in an amount of from 1 to 20, preferably from 2 to 15, and most preferably from 3 to 10 percent, based on the total resin solids. The cationic first compound comprising both polymer, A, and the carbamate functional reactive additive that is free of isocyanate functionality has been found to provide unexpected benefits in both application and performance.

In this preferred embodiment for the cationic first compound, the polymer, A, comprises one or more quaternary ammonium groups which serve as cationic salting sites. While it preferred that the polymer, A, comprises one or more quaternary ammonium groups, other cationic salting groups may also be present in the polymer, A. Examples of other suitable cationic salting groups are amine functional groups such as primary, secondary, tertiary amino groups or mixtures thereof.

The polymer, A, may be further characterized by a meq of cationic salting group, preferably a quaternary ammonium group, of from about 0.1 to 2.0 meq N/gram of the polymer, A, preferably from about 0.2 to 1.5 meq N/gram of the polymer, A, and most preferably from about 0.3 to 0.6 meq N/gram of the polymer, A. It is preferred that at least 80% of the total number of cationic salting groups be quaternary ammonium groups, more preferably from 90 to 100% of the total number of cationic salting groups, and most preferably from 95 to 100% of the total number. The remaining cationic salting groups can be as described above, with secondary amino groups being most preferred.

A preferred method of incorporating the necessary cationic salting group, i.e., a quaternary ammonium group into the polymer, A, is by reaction of a glycidyl group with one or acid salts of one or more tertiary amines. The acid salt will preferably be preformed via the mixing of one or more tertiary amines and one or more acids. Other amines or polyamines may be used having primary, secondary, tertiary amine groups, or mixtures thereof. However, it will be appreciated that quaternary ammonium groups are an especially preferred element of the polymer, A, of the cationic first compound. Suitable acids are carboxylic acids such as lactic acid and acetic acid.

Epoxy functionality will most preferably be present in the polymer, A, as a result of the foregoing reaction scheme wherein an isocyanate/carbamate functional intermediate compound is grafted onto a hydroxy/epoxy functional compound.

Alternatively, epoxy functionality can be incorporated into an acrylic resin via the polymerization of a monomer such as glycidyl methacrylate with an ethylenically unsaturated carbamate functional monomer to produce a carbamate functional acrylic having pendent glycidyl functionality. Subsequently, a cationic salting site, i.e., a quaternary ammonium compound can be incorporated by reaction of a tertiary amine with the oxirane group in the presence of an acid.

In the absence of an epoxy group, the cationic salting site can be incorporated into or grafted to the backbone of the polymer, A, in a variety of ways.

For example, a carbamate functional acrylic monomer can be copolymerized with an ethylenically unsaturated monomer having at least one cationic salting group. One or more carbamate functional monomers such as 2-carbamate ethyl methyacrylate (CEMA) may be copolymerized with at least one ethylenically unsaturated amine functional compound, at least one alkyl ester of an unsaturated organic acid and at least one other ethylenically unsaturated monomer such as styrene in the presence of a suitable initiator such as an azo or peroxide initiator. Other suitable carbamate functional monomers include those discussed above.

The cationic salting group of the ethylenically unsaturated monomer may be a primary, secondary, or tertiary amine functional group, or a quaternary ammonium salt, or a mixture thereof. Most preferably, the salting group will be a quaternary ammonium salt. Illustrative suitable unsaturated amine functional compounds are methacrylamide, acrylamide, dimethylaminoethyl methyacrylate, mixtures thereof, and the like. A preferred unsaturated amine functional compound is dimethylaminoethyl methyacrylate.

Examples of suitable alkyl esters of unsaturated organic acid include ethyl acrylate, butyl acrylate, 2-ethylhexyl acrylate, butyl methyacrylate, isodecyl methyacrylate, hydroxyethyl methacrylate, hydroxypropyl methacrylate, and the like. Preferred alkyl esters are nonhydroxy functional monomers such as butyl acrylate and butylmethacrylate. A preferred monomer for use as an additional ethylenically unsaturated monomer is styrene.

A preferred example of a suitable ethylenically unsaturated monomer having amino functionality is the reaction product of glycidyl methacrylate and the acid salt of a tertiary amine. Dimethylaminoethyl methacrylate is most preferred as the tertiary amine.

Despite that described above, in the most preferred embodiment of the subject invention, where the first curable coating composition is the cathodic electrocoat coating composition, the most preferred cationic first compound comprises an amine-modified epoxy resin as described in U.S. Pat. Nos. 4,882,090 and 4,988,420, the disclosures of which are herein incorporated by reference.

If the first curable coating composition is the cathodic electrocoat coating composition, then the cationic first compound is preferably reacted with an acid for use in the cathodic electrocoat coating composition of the invention. This reaction may be termed “neutralization or “acid-salted” and specifically refers to the reaction of the pendent amino groups with an acidic compound in an amount sufficient to neutralize enough of the basic amino groups to impart water-dispersibility to the cationic first compound. Illustrative acid compounds include phosphoric acid, propionic acid, acetic acid, lactic acid, citric acid, or formic acid.

The first curable coating composition further comprises the first curing agent. The first curing agent is a compound having a plurality of functional groups that are reactive with the active hydrogen-containing groups of the first compound. Such reactive groups include active methylol or methylalkoxy groups, isocyanate groups, siloxane groups, cyclic carbonate groups, and anhydride groups. Examples of compounds suitable for use as the first curing agent include aminoplast resins, phenolic resins, and combinations thereof. Additional compounds that are suitable for use as the first curing agent include phenol/formaldehyde adducts, polyisocyanate resins such as blocked polyisocyanate resins, tris(alkoxy carbonylamino) triazines (available from Cytec Industries under the tradename TACT) and mixtures thereof Aminoplast resins and phenol/formaldehyde adducts are most preferred, with blocked isocyanates feasible, but disfavored. Suitable aminoplast resins are amine/aldehyde condensates, preferably at least partially etherified, and most preferably fully etherified. Melamine and urea are preferred amines, but other triazines, triazoles, diazines, guanidines, or guanamines may also be used to prepare the alkylated amine/aldehyde aminoplast resins crosslinking agents. The aminoplast resins are preferably amine/formaldehyde condensates, although other aldehydes, such as acetaldehyde, crotonaldehyde, and benzaldehyde, may be used. Non-limiting examples of preferred aminoplast resins include monomeric or polymeric melamine formaldehyde resins, including melamine resins that are partially or fully alkylated using alcohols that preferably have one to six, more preferably one to four, carbon atoms, such as hexamethoxy methylated melamine; urea-formaldehyde resins including methylol ureas and siloxy ureas such as butylated urea formaldehyde resin, alkylated benzoguanimines, guanyl ureas, guanidines, biguanidines, polyguanidines, and the like. Monomeric melamine formaldehyde resins are particularly preferred. The preferred alkylated melamine formaldehyde resins are water miscible or water soluble.

The first compound and the first curing agent intended for use in the first curable coating composition are preferably dispersed in aqueous medium. The terms “dispersed” and “dispersion” as used within the context of the present invention are intended to indicate a two-phase translucent or opaque aqueous resinous system in which the resin is in the dispersed phase and water is in the continuous phase. It will be appreciated that in this case, the first curing agent may or may not be soluble in water. The average particle size diameter of the resinous phase is about 0.05 to 5.0 microns, preferably less than 2.0 microns.

The concentration of the first compound and the first curing agent in the aqueous medium is, in general, not critical, but ordinarily a major portion of the aqueous dispersion is water. The aqueous dispersion of the first curable coating composition will usually contain from about 3 to 50 percent, preferably from about 10 to 40 percent, by weight resin solids. Aqueous resin concentrates which are to be further diluted with water, generally range from 10 to 30 percent by total weight solids.

The first curable coating composition may, and most preferably will, contain one or more catalyst to facilitate the reaction between the first compound and the first curing agent. For example, a strong acid catalyst may be utilized to enhance the cure reaction. It will be appreciated that such catalysts may be blocked or unblocked. Such catalysts are well-known in the art and include, for example, p-toluenesulfonic acid, dinonylnaphthalene disulfonic acid, dodecylbenzenesulfonic acid (DDBSA), phenyl acid phosphate, monobutyl maleate, butyl phosphate, and hydroxy phosphate ester. Other catalysts useful in the composition of the invention include Lewis acids, zinc salts, and tin salts. Illustrative Lewis acids or zinc salts are zinc nitrate, zinc acetate, bismuth octoate, dibutyl tin dilaurate, and the like. Such catalysts will typically be used in an amount of from 0.1 to 3.0 weight percent, based on the resin solids, preferably from 0.5 to 2.0 weight percent, based on the resin solids. Preferred catalysts for use in the first curable coating composition are Lewis acids such as zinc nitrate and blocked and unblocked acid catalysts such as DDBSA. The above catalysts may also be used for the multistep production of the polymer, A, as described above.

In another preferred embodiment, the first curable coating composition further comprises an optional reactive additive such as is described in U.S. patent application Ser. No. 09/464,433, entitled “Cathodic Electrocoat Having A Carbamate Functional Resin And A Carbamate Functional Reactive Additive”, all of which is hereby incorporated by reference.

Compounds suitable for use as the optional reactive additive are those having at least one primary carbamate group and at least one alkyl radical selected from the group consisting of straight chain alkyl groups of more than 10 carbons, branched alkyl groups of from 5 to 30 carbons, and mixtures thereof.

As used herein, “primary carbamate group” refers to the functional group having the structure

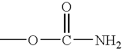

Thus, the primary carbamate group of the invention may be defined as a terminal or pendent carbamate group. Although compounds suitable for use as the optional reactive additive may comprise more than one primary carbamate group, it is most preferred that such compounds have one primary carbamate group.

In addition to the at least one primary carbamate group, compounds suitable for use as the optional reactive additive further comprise at least one alkyl group selected from the group consisting of branched alkyl groups having from 5 to 30 total carbons, straight chain alkyl groups of more than 10 carbons, and mixtures thereof.

As used herein, the term “branched” refers to both lateral branches and forked branches. Lateral refers to a branch of two small chains at the end atom of a carbon chain. Forked refers to a branch of two small chains in the middle of a carbon chain. For the purposes of the instant invention a carbon chain may be from 1 to 15 carbons, more preferably from 1 to 8 and most preferably from 1 to 3. The total number of carbon atoms in the branched alkyl group is obtained by adding the total number of carbons in the main carbon chain+the number of carbons in all alkyl chains extending from the main carbon chain.

It is to be appreciated that the main carbon chain may be from 1 to 25 carbons, preferably from 1 to 10, most preferably from 1 to 4. Most preferably, the main chain will be an, aliphatic carbon chain free of unsaturation. Although the at least one branched alkyl group may comprise from 5 to 30 total carbons, more preferably, it will have from 5 to 15 carbons and most preferably from 8 to 12 carbons.

Finally, it will be appreciated that suitable “at least one alkyl groups” for use in the optional reactive additive are substantially free of functional groups that are reactive with one or more of the polymer, A, and the carbamate functional reactive additive. Thus, the at least one alkyl group selected from the group consisting of branched alkyl groups having from 5 to 30 total carbons, straight chain alkyl groups of more than 10 carbons, and mixtures thereof, will be free of hydroxyl groups and the like.

An example of an especially suitable at least one branched alkyl group is

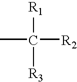

wherein R₁, R₂, and R₃ are alkyl groups of from 1 to 10 carbons each, preferably aliphatic groups of from 1 to 10 carbons. Most preferably, R₁, R₂, and R₃ will total from 8 to 12 carbons with at least one of R₁, R₂, and R₃ being a methyl group.

In another suitable branched alkyl group of the same structure, one of R₁, R₂, and R₃, may be hydrogen, with the other substituent groups being alkyl groups of from 1-10 carbons, preferably aliphatic groups of from 1 to 10. An example of such a group is

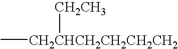

In this instance, the above structure is understood to be an example of lateral branching.

In a particularly preferred embodiment, the at least one branched alkyl group will comprise

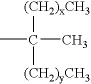

wherein x+y=5 carbons.

Alternatively, the compound suitable for use as the optional reactive additive may include a straight chain alkyl group of more than 10 carbons, preferably more than 15 carbons and most preferably more than 18. Examples of suitable straight chain, aliphatic alkyl groups include 1-eicosanyl, 1-octadecyl, 1-arachidyl, 1-dodecyl, 1-decyl, and 1-octyl, and the like. It is most preferred that compounds suitable for use as the optional reactive additive include at least one group which is a branched alkyl group such as described above.

Compounds suitable for use as the optional reactive additive may further include heteratoms such as O and N, most preferably O. Such heteratoms may be incorporated in the form of groups such as esters, hydroxyls, ether, carboxyls, mixtures thereof and the like. Preferred are esters, hydroxyls, and mixtures thereof. Most preferably, a compound will comprise at least one hydroxyl group and one ester group in addition to the carbamate functional group and the at least one alkyl group. As indicated above, such heteratoms may not be present in the branched alkyl group nor in the straight alkyl chain group of more than 10 carbons.

Particularly suitable compounds for use as the optional reactive additive are those having the formula:

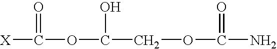

wherein X is a branched alkyl radical of from 5 to 30 total carbons, more preferably from 5 to 15 total carbons and most preferably from 8 to 12 total carbons.

A further preferred compound for use as the optional reactive additive is that having the formula:

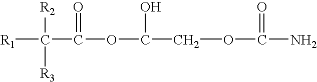

wherein R₁, R₂, and R₃ are each alkyl groups of from 1 to 10 carbons, especially compounds wherein R₁, R₂, and R₃ total from 8 to 12 carbons with at least one of R₁, R₂, and R₃ being a methyl group.

The most preferred compound for use as the optional reactive additive is that having the formula:

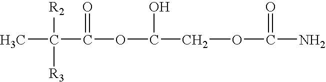

wherein R₂ and R₃ are respectively —(CH₂)ₓCH₃ and —(CH₂)_{y}CH₃ wherein x+y=5.

Besides water, the aqueous medium of the first curable coating composition may also contain a coalescing solvent. Useful coalescing solvents include hydrocarbons, alcohols, esters, ethers and ketones. The preferred coalescing solvents include alcohols, polyols and ketones. Specific coalescing solvents include monobutyl and monohexyl ethers of ethylene glycol, and phenyl ether of propylene, ethylene glycol butyl ether, ethyleneglycol dimethyl ether, or mixtures thereof. A small amount of a water-immiscible organic solvent such as xylene, toluene, methyl isobutyl ketone or 2-ethylhexanol may be added to the mixture of water and the water-miscible organic solvent. The amount of coalescing solvent is not unduly critical and is generally between about 0 to 15 percent by weight, preferably about 0.5 to 5 percent by weight based on total weight of the resin solids.

The first curable coating composition may further contain conventional pigments such as titanium dioxide, ferric oxide, aluminum silicate, precipitated barium sulfate, aluminum phosphomolybdate, strontium chromate, basic lead silicate or lead chromate. The pigment-to-resin weight ratio can be important and should be preferably less than 50:100, more preferably less than 40:100, and usually about 10 to 30:100. Higher pigment-to-resin solids weight ratios have also been found to adversely affect coalescence, flow, and/or coating performance.

The first curable coating composition can contain optional ingredients such as wetting agents, surfactants, defoamers, antioxidants, UV absorbers, light stabilizers, and so forth. However, in the most preferred embodiment of the subject invention, the first curable coating composition is free of any flow control additives. Examples of flow control additives that are not preferred for use in the subject invention include, without limitation, fumed silicas, microgels, and the like. Generally, any type of flow control additive that operates by increasing the low shear viscosity of a film of the first curable coating composition is not desirable because such additives also increase the surface roughness. Examples of surfactants and wetting agents include alkyl imidazolines such as those available from Ciba-Geigy Industrial Chemicals as Amine C®, acetylenic alcohols available from Air Products and Chemicals as Surfynol® 104. These optional ingredients, when present, constitute from about 0 to 20 percent by weight of resin solids, and preferably from 0.1 to 1.0 percent by weight of resin solids. Plasticizers are optional ingredients because they promote flow. Examples are high boiling water immiscible materials such as polyalkylene polyols, such as polypropylene polyols or ethylene or propylene oxide adducts of nonyl phenols or bisphenol A. Plasticizers can be used and if so are usually used at levels of about 0 to 15 percent by weight resin solids.

In general, sufficient water is added so that the dispersion of the first curable coating composition has a solids content of more than 20, preferably more than 30% by weight.

The first curable coating composition is applied to the substrate by electrophoretic deposition at a nonvolatile content of 10 to 25% by weight to a dry film thickness of from 10 to 35 microns. Electrodeposition of the first curable coating composition according to the invention may be carried out by any of a number of processes known to those skilled in the art. The deposition may be carried out on all electrically conducting substrates, for example metal, such as steel, copper, aluminum and the like. As stated above, the most preferred electrically conducting substrate is the automotive body panel.

The first curable coating composition also includes the electroconductive additive. The electroconductive additive is suitable for providing a first coating layer, which results from a cure of the first curable coating composition, with an electrical conductivity on the substrate of at least 130 S/cm. In the most preferred embodiment, the electroconductive additive includes electroconductive carbon black pigment.

The electroconductive carbon black pigments used according to the subject invention are distinguished by an iodine absorption of from 870 to 930 mg/g, a specific surface area (BET/N₂) of from 850 to 1,150 m²/g, a pore volume (DBP) of from 330 to 470 ml/100 g, and an average particle size of from 25 to 35 nm. One electroconductive carbon black pigment found to be particularly suitable has an iodine absorption of from 890 to 910 mg/g, a specific surface area (BET/N₂) of from 975 to 1,025 m²/g, a pore volume (DBP) of from 360 to 440 ml/100 g, and an average particle size of 30 nm. Suitable electroconductive carbon black pigments are commercially available from Akzo Chemie under the trademark KETJENBLACK EC and from Degussa Corporation under the trademark Printex XE 2.

In the most preferred embodiment, to provide sufficient electrical conductivity, the electroconductive carbon black pigment is present in an amount from 1.5 to 5.1 parts by weight based on 100 parts by weight of total solids of the first curable coating composition. The electroconductive carbon black pigment used in the first curable coating composition can be used in this relatively low concentration, especially where the first curable coating composition is the cathodic electrocoat coating composition, and still provide an electrophoretically over-coatable coating with a high degree of application reliability. The particular electroconductive carbon black pigment provides electrophoretically over-coatable coatings that are over-coatable, not only by subsequent cathodic electrocoat coating compositions, but also by subsequent anodic electrocoat coating compositions. If the first curable coating composition comprises less than 1.5 parts by weight, based on total solids, then the first coating layer can not be electrophoretically over-coated with a subsequent electrocoat coating composition. On the other hand, if the first curable coating composition comprises more than 5.1 parts by weight, based on total solids, then the first coating layer has unacceptable surface flaws, such as craters or pinholes.

Once the first curable coating composition is applied to the substrate, the coated substrate is subjected to an amount of energy sufficient to cause the coated substrate to become a conductive coated substrate. More specifically, the coated substrate is subject to an amount of energy that is sufficient to cause the conductive coated substrate to have the electrical conductivity of at least 130 S/cm due to the electroconductive additive. The first coating layer results from curing of the first curable coating composition.

It is to be understood that subjecting the coated substrate to the amount of energy that is sufficient to cause the coated substrate to become conductive, does not necessarily require complete cross-linking and complete cure of the first curable coating composition. Instead, so long as the coated substrate is able to cure enough to achieve conductivity, the coated substrate can remain partially ‘wet’ or partially uncured where the first coating layer is subjected to conditions that eliminate volatiles, such as solvent and water, and/or reduce the volume of the first coating layer, but do not establish complete cross-linking and complete cure. Frequently, the energy conditions that do not establish complete cross-linking and complete cure are referred to as a ‘flash’ where the coated substrate is, for a relatively short period of time such as from 1 to 10 minutes, subjected to slightly elevated temperatures ranging from 140 to 225° F. In view of that described above, use of the terminology ‘cure’ throughout the subject description does not necessarily require complete cure.

In the most preferred embodiment, after application of the first curable coating composition, the coated substrate is subjected to elevated temperatures that do achieve complete cross-linking and complete cure. As understood by those skilled in the art, the particular elevated temperature depends upon the nature of particular resins, i.e., the particular first compound and the particular first curing agent. In general, again depending on the particular first compound and first curing agent, the coated substrate is cured by exposure to a temperature of 375° F. or less for 45 minutes or less. More specifically, the coated substrate is cured by exposure to temperatures ranging from 212 to 390° F., preferably from 325 to 375° F., and most preferably 350° F., for from 10 to 45 minutes the most preferred embodiment where the first compound is the amine-modified epoxy resin in the cathodic electrocoat coating composition, the coated substrate is cured at 350° F. for 30 minutes such that the actual surface temperature of the substrate reaches 350° F. for at least 20 minutes. The coated substrate may be subjected to the energy in traditional baking ovens, which are most preferred, or upon exposure to infrared or blackwall radiation. Also, it is to be understood that if the carbamate functionality describe above is employed in the first curable coating composition, then the first curable coating composition will preferably cure at lower temperatures, generally around from 250 to 300° F. for from 15 to 30 minutes.

After the coated substrate is cured to become the conductive coated substrate, a second curable coating composition is applied to the conductive coated substrate. A multicoated substrate is now established from application of the second curable coating composition to the conductive coated substrate. The second curable coating composition can be applied to the conductive coated substrate by electrophoretic deposition, just as the first curable coating composition, or by spray application. Electrophoretic deposition of the second curable coating composition is most preferred. As for spray application of the second curable coating composition, the electrical conductivity of the first coating layer remains important because effective and safe electrostatic spray application of the second curable coating composition requires that the first coating layer possesses sufficient electrical conductivity. Although not preferred, the second curable coating composition may be applied by other application methods including, but not limited to, powder slurry spray application, powder coating via fluidized bed, and the like. The second curable coating composition is applied to the substrate to a dry film thickness of from 10 to 35 microns.

The second curable coating composition comprises a second compound and a second curing agent. More specifically, the second compound comprises one or more active hydrogen-containing groups, and the second curing agent comprises one or more functional groups that are reactive with the active hydrogen-containing groups of the second compound. Also, as with the first curable coating composition, suitable second curable coating compositions may be either an anodic or a cathodic electrocoat coating composition. If the second curable coating composition is electrophoretically deposited and is either an anodic or a cathodic electrocoat coating composition, then the above description for the first compound and the first curing agent applies to the second compound and the second curing agent respectively. On the other hand, if the second curable coating composition is spray applied, then the second curable coating composition may be either a solventborne or a waterborne coating composition. Additionally, the second curable coating composition may be a powder or powder slurry coating composition.

More specifically, if the second curable coating composition is spray applied, then the second curable coating composition may be a waterborne primer surfacer, a waterborne sealer, a waterborne basecoat, a waterborne clearcoat, a solventborne primer surfacer, a solventborne sealer, a solventborne basecoat, a solventborne clearcoat, or mixtures thereof. Most preferably, the second curable coating composition is a primer surfacer, i.e., a primer surfacer coating composition. Aqueous coating compositions or those having low concentrations of volatile organic compounds (VOC). Consequently, the powder and the powder slurry coating compositions may be preferred.

If the second curable coating composition is spray applied, then examples of suitable second compounds include all well known polymers and/or resins such as acrylics, polyesters, epoxys, polyurethanes, vinyl, polycarbonates, alkyds, polysiloxanes, and mixtures and copolymers thereof. Acrylic, polyurethane, and polyester resins and mixtures thereof, are preferred, with acrylic, polyurethane and mixtures thereof being most preferred. The one or more active hydrogen-containing groups may thus be selected from the group -consisting of hydroxyl, carboxylic acid, epoxy, carbamate, isocyanate, amine, acrylate, vinyl, silane, acetoacetate, mixtures thereof, and the like. Hydroxyl groups are most preferred.

A most preferred second compound in the embodiment where the second curable coating composition is spray applied comprises a combination of a polyurethane polymer and an acrylic polymer. The polyurethane polymer will most preferably have a glass transition temperature of about 0° C. or less. The acrylic polymer will most preferably have a glass transition temperature that is at least about 20° C. higher than the glass transition temperature of polyurethane resin.

The polyurethane polymer preferred for use as the second compound has a glass transition temperature of about 0° C. or less, preferably about −20° C. or less, and more preferably about −30° C. or less. The glass transition temperature of the polyurethane polymer is in the range of from about −80° C. to about 0° C., more preferably from about −65° C. to about −10° C., still more preferably from about −65° C. to about −30° C., and even still more preferably from about −60° C. to about −35° C.

The weight average molecular weight of the polyurethane polymer preferred for use as the second compound is preferably from about 15,000 to about 60,000, more preferably from about 15,000 to about 60,000, and even more preferably from about 20,000 to about 35,000.

Polyurethanes are prepared by reaction of at least one polyisocyanate and at least one polyol. The reactants used to prepare the polyurethane are selected and apportioned to provide the desired glass transition temperature. Suitable polyisocyanates include, without limitation, aliphatic linear and cyclic polyisocyanates, preferably having up to 18 carbon atoms, and substituted and unsubstituted aromatic polyisocyanates. Illustrative examples include, without limitation, ethylene diisocyanate, 1,2-diisocyanatopropane, 1,3-diisocyanatopropane, 1,4-butylene diisocyanate, lysine diisocyanate, 1,4-methylene bis(cyclohexyl isocyanate), isophorone diisocyanate, toluene diisocyanates (e.g., 2,4-toluene diisocyanate and 2,6-toluene diisocyanate) diphenylmethane 4,4′-diisocyanate, methylenebis-4,4′-isocyanatocyclohexane, 1,6-hexamethylene diisocyanate, p-phenylene diisocyanate, tetramethyl xylene diisocyanate, meta-xylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, and combinations of two or more of these. Biurets, allophonates, isocyanurates, carbodiimides, and other such modifications of these isocyanates can also be used as the polyisocyanates. In a preferred embodiment, the polyisocyanates include methylenebis-4,4′-isocyanatocyclohexane, 1,6-hexamethylene diisocyanate, 1,12-dodecamethylene diisocyanate, and combinations thereof. It is particularly preferred to use at least one α.ω-alkylene diisocyanate having four or more carbons, preferably 6 or more carbons, in the alkylene group. Combinations of two or more polyisocyanates in which one of the polyisocyanates is 1,6-hexamethylene diisocyanate are especially preferred.

The polyol or polyols used to prepare the polyurethane polymer can be selected from any of the polyols known to be useful in preparing polyurethanes, including, without limitation, 1,4-butanediol, 1,3-butanediol, 2,3-butanediol, 1,6-hexanediol, neopentyl glycol, 1,3-propanediol, 1,5-pentanediol, 1,6-hexanediol, 1,9-nonanediol, ethylene glycol, diethylene glycol, triethylene glycol and tetraethylene glycol, propylene glycol, dipropylene glycol, glycerol, cyclohexanedimethanols, 2-methyl-2-ethyl-1,3-propanediol, 2-ethyl-1,3-hexanediol, thiodiglycol, 2,2,4-trimethyl-1,3-pentanediol, cyclohexanediols, trimethylolpropane, trimethylolethane, and glycerin; polyester polyols such as the reaction products of any of the foregoing alcohols and combinations thereof with one or more polycarboxylic acids selected from malonic acid, maleic acid, succinic acid, glutaric acid adipic acid, azelaic acid, anhydrides thereof, and combinations thereof; polyether polyols, such as polyethylene glycols and polypropylene glycols; and combinations of such polyols. Polyols having two hydroxyl groups are preferred. The polyurethane is preferably prepared using one or more polyester polyols. In a preferred embodiment, the polyester polyol is the reaction product of a mixture that comprises neopentyl glycol and adipic acid.

While it is possible to prepare a nonionic dispersion of the polyurethane, the polyurethane dispersion used as part of the most preferred second compound in this embodiment is preferably anionic. Acid-functional polyurethanes that can be salted to form anionic dispersions or emulsions may be synthesized by including a monomer having acid functionality, such as, without limitation, dialkylpropionic acids including dimethylolpropionic acid, and alkali metal salts of amino acids such as taurine, methyl taurine, 6-amino caproic acid, glycine, sulfanilic acid, diamino benzoic acid, ornithine, lysine and 1:1 adducts of sultones, such as propane sultone or butane sultone, with diamines, such as ethylene diamine, hydrazine, or 1,6-hexamethylene diamine. The hydroxyl groups react to form the urethane linkages while the acid group remains unreacted in the polyurethane polymerization.

Suitable polyurethane polymers can be prepared by any of the known methods. In one method for preparing polyurethane polymers, the polyisocyanate component is reacted with an excess of equivalents of the polyol component to form a hydroxyl-functional polyurethane polymer. Alternatively, an excess of equivalents of the polyisocyanate component can be reacted with the polyol component to form an isocyanate-functional prepolymer. The prepolymer can then be reacted further in different ways. First, the prepolymer can be reacted with a mono-functional alcohol or amine to provide a non-functional polyurethane polymer. Examples of mono-functional alcohols and amines that may be used include polyethylene oxide compounds having one terminal hydroxyl group, lower mono-functional alcohols having up to 12 carbon atoms, amino alcohols such as dimethylethanolamine, and secondary amines such as diethylamine and dimethylamine. Secondly, the prepolymer can be reacted with a polyfunctional polyol, polyamine, or amino alcohol compound to provide reactive hydrogen functionality. Examples of such polyfunctional compounds include, without limitation, the polyols already mentioned above, including triols such as trimethylolpropane; polyamines such as ethylenediamine, butylamine, and propylamine; and amino alcohols, such as diethanolamine. Finally, the prepolymer can be chain extended by the water during emulsification or dispersion of the prepolymer in the aqueous medium. The prepolymer is mixed with the water after or during neutralization.

The polyurethane preferred as part of the second compound in this embodiment may be polymerized without solvent. Solvent may be included, however, if necessary, when the polyurethane or prepolymer product is of a high viscosity. If solvent is used, the solvent may be removed, partially or completely, by distillation, preferably after the polyurethane is dispersed in the water. The polyurethane may have nonionic hydrophilic groups, such as polyethylene oxide groups, that serve to stabilize the dispersed polyurethane polymer. In a preferred embodiment, however, the polyurethane polymer is prepared with pendant acid groups as described above, and the acid groups are partially or fully salted with an alkali, such as sodium or potassium, or with a base, such as an amine, before or during dispersion of the polyurethane polymer or prepolymer in water.

In the most preferred embodiment where the second curable coating composition is spray applied, the second compound also includes the acrylic polymer. The acrylic polymer is prepared according to usual methods, such as by bulk or solution polymerization followed by dispersion in an aqueous medium or, preferably, by emulsion polymerization in an aqueous medium. The acrylic polymer is polymerized from a monomer mixture that preferably includes an active hydrogen-functional monomer and preferably includes an acid-functional monomer. Examples of active hydrogen-functional monomers include, without limitation, hydroxyl-functional monomers such as hydroxyethyl acrylate, hydroxyethyl methacrylate, hydroxypropyl acrylate, hydroxypropyl methacrylate, hydroxybutyl acrylates, and hydroxybutyl methacrylates; and carbamate- and urea-functional monomers or monomers with functional groups that are converted to carbamate or urea groups after polymerization such as, without limitation, those disclosed in U.S. Pat. No. 5,866,259, “Primer Coating Compositions Containing Carbamate-Functional Acrylic Polymers,” the entire disclosure of which is incorporated herein by reference. Preferably, a sufficient amount of active hydrogen-functional monomer is included to produce an equivalent weight of 1000 or less grams per equivalent, more preferably 800 or less grams per equivalent, and even more preferably 600 or less grams per equivalent.

It is preferred that the acrylic polymer preferred for use as part of the second compound in this embodiment be dispersed as an anionic dispersion. Examples of suitable acid-functional monomers include, without limitation, α,β-ethylenically unsaturated monocarboxylic acids containing 3 to 5 carbon atoms, α,β-ethylenically unsaturated dicarboxylic acids containing 4 to 6 carbon atoms and the anhydrides and monoesters of these. Examples include, without limitation, acrylic acid, methacrylic acid, crotonic acid, maleic acid or maleic anhydride, itaconic acid or itaconic anhydride, and so on. A sufficient amount of acid-functional monomer is included to produce an acrylic polymer with an acid number of at least about 1, and preferably the acrylic polymer has an acid number of from about 1 to about 10.

In addition to the ethylenically unsaturated monomer having acid functionality or used to generate acid functionality in the finished polymer, one or more other ethylenically unsaturated monomers are employed as comonomers in forming the acrylic resins preferably used in this second compound. Examples of such copolymerizable monomers include, without limitation, derivatives of α,β-ethylenically unsaturated monocarboxylic acids containing 3 to 5 carbon atoms, including esters, nitriles, or amides of those acids; diesters of α,β-ethylenically unsaturated dicarboxylic acids containing 4 to 6 carbon atoms; vinyl esters, vinyl ethers, vinyl ketones, vinyl amides, and aromatic or heterocyclic aliphatic vinyl compounds. Representative examples of acrylic and methacrylic acids, amides and aminoalkyl amides include, without limitation, such compounds as acrylamide, N-(1,1-dimethyl-3-oxobutyl)-acrylamide, N-alkoxy amides such as methylolamides; N-alkoxy acrylamides such as n-butoxy acrylamide; N-aminoalkyl acrylamides or methacrylamides such as aminomethylacrylamide, 1-aminoethyl-2-acrylamide, 1-aminopropyl-2-acrylamide, 1-aminopropyl-2-methacrylamide, N-1-(N-butylamino)propyl-(3)-acrylamide and 1-aminohexyl-(6)-acrylamide and 1-(N,N-dimethylamino)-ethyl-(2)-methacrylamide, 1-(N,N,-dimethylamino)-propyl-(3)-acrylamide and 1-(N,N-dimethylamino)-hexyl-(6)-methacrylamide.

Representative examples of esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tertbutyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates; and polyalkylene glycol acrylates and methacrylates.

Representative examples of other ethylenically unsaturated polymerizable monomers include, without limitation, such compounds as fumaric, maleic, and itaconic anhydrides, monoesters, and diesters. Polyfunctional monomers may also be included to provide a partially crosslinked acrylic dispersion. Examples of polyfunctional compounds include, without limitation, ethylene glycol diacrylate, ethylene glycol dimethyacrylate, triethylene glycol diacrylate, tetraethylene glycol dimethacrylate, 1,6-hexanediol diacrylate, divinylbenzene, trimethylolpropane triacrylate, and so on.

Representative examples of vinyl monomers that can be copolymerized include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, α-methyl styrene, vinyl toluene, tert-butyl styrene, and 2-vinyl pyrrolidone.

After polymerization, the acid functionality is salted, preferably with an alkali or base, preferably an amine. Example of suitable salting materials include, without limitation, ammonia, monoethanolamine, ethylamine, dimethylamine, diethylamine, triethylamine, propylamine, dipropylamine, isopropylamine, diisopropylamine, triethanolamine, butylamine, dibutylamine, 2-ethylhexylamine, ethylenediamine propylenediamine, ethylethanolamine, dimethylethanol amine, diethylethanolamine, 2-amino-2-methylpropanol, and morpholine. Preferred salting materials include 2-amino-2-methylpropanol and dimethylethanolamine.

The acrylic polymers used in the preferred second compounds where the second curable coating composition is spray applied may be prepared as solutions in an organic solvent medium, preferably selected from water-soluble or water-miscible organic solvents, and then dispersed into water. After dispersion into water, the organic solvent can be distilled from the aqueous dispersion or emulsion.

In a preferred method, the acrylic polymer preferred for use as the second compound in this embodiment is provided by emulsion polymerization. Preferably, a nonionic or an anionic surfactant is used for the emulsion polymerization. Suitable surfactants include, without limitation, polyoxyethylenenonylphenyl ethers, polyoxyethylenealkylallyl ether sulfuric acid esters, amino and alkali salts of dodecylbenzenesulfonic acid such as the dimethylethanolamine salt of dodecylbenzenesulfonic acid and sodium dodecylbenzenesulfonic acid, and sodium dioctylsulfosuccinate.

The polymerization typically proceeds by free radical polymerization. The free radical source is typically supplied by a redox initiator or by an organic peroxide or azo compound. Useful initiators include, without limitation, ammonium peroxydisulfate, potassium peroxydisulfate, sodium metabisulfite, hydrogen peroxide, t-butyl hydroperoxide, dilauryl peroxide, t-butyl peroxybenzoate, 2,2′-azobis(isobutyronitrile), and redox initiators such as ammonium peroxydisulfate and sodium metabisulfite with ferrous ammonium sulfate. Optionally, a chain transfer agent may be used. Typical chain transfer agents include mercaptans such as octyl mercaptan, n- or tert-dodecyl mercaptan, thiosalicylic acid, mercaptoacetic acid, and mercaptoethanol; halogenated compounds; and dimeric alpha-methyl styrene.

Acrylic polymers prepared by emulsion polymerization can have weight average molecular weights of one million or more. The weight average molecular weight of the acrylic dispersion is preferably from about 5,000 to about 5,000,000, more preferably from about 7500 to about 500,000, and even more preferably from about 10,000 to about 50,000. If prepared by solution polymerization and then dispersed in water, the acrylic polymer will generally have a number average molecular weight of from about 5000 to about 60,000. The molecular weight can be determined by gel permeation chromatography using a polystyrene standard or other known methods.

The theoretical glass transition temperature of the acrylic polymer can be adjusted according to methods well-known in the art through selection and apportionment of the comonomers. The acrylic polymer has a glass transition temperature that is at least about 20° C. higher than the glass transition temperature of polyurethane resin. Preferably, the acrylic polymer has a glass transition temperature that is at least about 40° C. higher, more preferably about 50° C. higher, than the glass transition temperature of polyurethane resin. In a preferred embodiment, the theoretical T_{g} of the acrylic polymer is between about −30° C. and 80° C., more preferably between about −20° C. and 40° C.

In the most preferred compound where the second curable coating composition is spray applied, the polyurethane polymer will be included in the second compound in an amount of at least about 40% by weight, preferably at least about 50% by weight, based on the total nonvolatile weight of the second compound. The polyurethane polymer may be included in the second compound in an amount of up to about 98% by weight, preferably up to about 80% by weight, based on the total nonvolatile weight of the second compound. It is preferred to include from about 50% by weight to about 75% by weight, and even more preferred to include from about 65% by weight to about 75% by weight, of the polyurethane polymer, based on the total nonvolatile weight of the second compound.

The second curable coating composition further comprises the second curing agent. As stated above, the second curing agent comprises the one or more functional groups that are reactive with the active hydrogen-containing groups of the second compound. Such reactive groups include active methylol or methylalkoxy groups, isocyanate groups, siloxane groups, cyclic carbonate groups, and anhydride groups. Examples of compounds suitable for use as the second curing agent include aminoplast resins, phenol/formaldehyde adducts, blocked isocyanate curing agents, tris(alkoxy carbonylamino)triazines (available from Cytec Industries under the tradename TACT) and mixtures thereof. Aminoplast resins and phenol/formaldehyde adducts are most preferred, with blocked isocyanates being feasible, yet disfavored. Suitable aminoplast resins are amine/aldehyde condensates, preferably at least partially etherified, and most preferably fully etherified. Melamine and urea are preferred amines, but other triazines, triazoles, diazines, guanidines, or guanamines may also be used to prepare the alkylated amine/aldehyde aminoplast resins crosslinking agents. The aminoplast resins are preferably amine/formaldehyde condensates, although other aldehydes, such as acetaldehyde, crotonaldehyde, and benzaldehyde, may be used. Non-limiting examples of preferred aminoplast resins include monomeric or polymeric melamine formaldehyde resins, including melamine resins that are partially or fully alkylated using alcohols that preferably have one to six, more preferably one to four, carbon atoms, such as hexamethoxy methylated melamine; urea-formaldehyde resins including methylol ureas and siloxy ureas such as butylated urea formaldehyde resin, alkylated benzoguanimines, guanyl ureas, guanidines, biguanidines, polyguanidines, and the like. Monomeric melamine formaldehyde resins are particularly preferred. The preferred alkylated melamine formaldehyde resins are water miscible or water soluble.

The second curing agent may generally be present in curable coating composition in an amount of from 1 to 50% by weight, preferably from about 2% by weight to about 30% by weight, more preferably from about 5% by weight to about 20% by weight, and particularly preferably about 5% to about 15% by weight of the total nonvolatile weight of the second compound and the second curing agent.

As with the first curable coating composition, the second curable coating composition may, and most preferably will, contain one or more catalyst to facilitate the reaction between the second compound and the second curing agent. The catalysts described above with respect to the first curable coating composition are also suitable for use in the second curable coating composition.

As stated above, the second curable coating composition may be a solventborne or waterborne coating composition, including an aqueous powder slurry coating composition. Also, as in the case of the powder coating composition described above, the second curable coating composition can be applied without solvent. However, if solvents are utilized in the second curable coating composition, the solvent should function as a solvent with respect to both the second compound and the second curing agent. In general, depending on the solubility characteristics of the second compound and the second curing agent, the solvent can be any organic solvent and/or water. In one preferred embodiment, the solvent is a polar organic solvent. More preferably, the solvent is a polar aliphatic solvents or polar aromatic solvents. Still more preferably, the solvent is a ketone, ester, acetate, aprotic amide, aprotic sulfoxide, or aprotic amine. Examples of useful solvents include methyl ethyl ketone, methyl isobutyl ketone, amyl acetate, ethylene glycol butyl ether-acetate, propylene glycol monomethyl ether acetate, xylene, N-methylpyrrolidone, or blends of aromatic hydrocarbons. In another embodiment, the solvent can be water or a mixture of water with co-solvents.

In some preferred embodiments, the second curable coating composition may be a waterborne coating composition. Besides water, the waterborne coating composition may also contain a coalescing solvent. Useful coalescing solvents include hydrocarbons, alcohols, esters, ethers and ketones. The preferred coalescing solvents include alcohols, polyols and ketones. Specific coalescing solvents include monobutyl and monohexyl ethers of ethylene glycol, and phenyl ether of propylene, ethylene glycol butyl ether, ethyleneglycol dimethyl ether, or mixtures thereof. A small amount of a water-immiscible organic solvent such as xylene, toluene, methyl isobutyl ketone or 2-ethylhexanol may be added to the mixture of water and the water-miscible organic solvent. The amount of coalescing solvent is not unduly critical and is generally between about 0 to 15 percent by weight, preferably about 0.5 to 5 percent by weight based on total weight of the resin solids.

In a particularly preferred embodiment, the second curable coating composition has a very low content of volatile organic solvent. In another particularly preferred embodiment, the second curable coating composition is an aqueous powder slurry coating composition. In this embodiment, the polyurethane dispersion used as part of the second compound is preferably prepared as a solvent free, or a substantially solvent free, dispersion. By “substantially solvent free” it is meant that the dispersion has a volatile organic content of less than about 5% by weight of the second curable coating composition. The acrylic dispersion also used in the second compound is also preferably a solvent free, or substantially solvent free, dispersion. In this embodiment, the second curable coating composition has a VOC of less than about 1.5, more preferably less than about 1.3, and even more preferably less than about 0.7. The VOC of the second curable coating composition is typically measured using ASTM D3960.

The second curable coating composition may further comprise pigments that are commonly used in the art, such as color pigments, corrosion inhibiting pigments, conductive pigments, and filler pigments. Suitable examples include, without limitation, titanium dioxide, metal oxides such as ferric oxide, carbon black, silicates such as aluminum silicate and basic lead silicate, sulfates such as precipitated barium sulfate, molybdates such as aluminum phosphomolybdate, chromates such as strontium chromate and lead chromate, phosphates, silicas, and mixtures thereof . The pigment-to-resin weight ratio can be important and should be preferably less than 50:100, more preferably less than 40:100, and usually about 10 to 30:100. In this embodiment, where the second curable coating composition is spray applied, pigments are typically incorporated into the second curable coating composition such that the second curable coating composition is a color-keyed primer surfacer coating composition, i.e., a primer surfacer that corresponds in color to a subsequently applied basecoat. With the color-keyed primer surfacer, the subsequently applied basecoat can be applied at lower film builds.

As with the first curable coating composition, the second curable coating composition can contain optional ingredients such as wetting agents, surfactants, defoamers, antioxidants, UV absorbers, light stabilizers, and so forth. However, in the most preferred embodiment of the subject invention, the second curable coating composition is free of any flow control additives just like the first curable coating composition. Examples of flow control additives that are not preferred for use in the subject invention include, without limitation, fumed silicas, microgels, and the like. Examples of surfactants and wetting agents include alkyl imidazolines such as those available from Ciba-Geigy Industrial Chemicals as Amine C®, acetylenic alcohols available from Air Products and Chemicals as Surfynol® 104. These optional ingredients, when present, constitute from about 0 to 20 percent by weight of resin solids, and preferably from 0.1 to 1.0 percent by weight of resin solids. Plasticizers are optional ingredients because they promote flow. Examples are high boiling water immiscible materials such as polyalkylene polyols, such as polypropylene polyols or ethylene or propylene oxide adducts of nonyl phenols or bisphenol A. Plasticizers can be used and if so are usually used at levels of about 0 to 15 percent by weight resin solids.

After the second curable coating composition is applied to the conductive coated substrate to establish the multicoated substrate, the multicoated substrate is subjected to a particular amount of energy. The amount of energy that the multicoated substrate is subject to is sufficient for cross-linking both the first and second curable coating compositions. A second coating layer results from the cross-linking and curing of the second curable coating composition.

It is to be understood that since, if the first curable coating composition remains wet or uncured, then the first and second curable coating compositions are jointly cured. On the other hand, if, as in the most preferred embodiment, the first curable coating composition is already completely cross-linked and cured, it is only the second curable coating composition that is being cross-linked and cured at this stage. However, as described above, because the first curable coating composition may remain in a wet or uncured state, the particular amount of energy that the multicoated substrate is subjected to must be sufficient to completely cross-link and cure both the first and second curable coating compositions.

In the most preferred embodiment, the multicoated substrate is subjected to elevated temperatures in a traditional baking oven to ensure cross-linking and curing of both the first and second curable coating compositions, depending on the particular resins used as the first and second compounds and as the first and second curing agents. Generally, the multicoat substrate is subjected to an elevated temperature of 375° F. or less for 45 minutes or less. The entire description set forth above with respect to the exposure of the first curable coating composition to the various forms of energy to make the first coating layer electrically conductive applies to the cure of the second curable coating composition, including the various possible temperature ranges and time intervals.

The cured multilayer coating, made from the cross-linked first and second curable coating compositions, provides the improved edge corrosion resistance to the substrate. More specifically, the edge corrosion resistance, as measured according to the Edge Corrosion Test, is improved by at least 100%, as compared to the electrocoats of the prior art, including those particularly discussed in the Background of the Invention section (also see the Examples below).

In the Edge Corrosion Test, the first and second curable coating compositions are applied to knife, or razor, blades, having dimensions of ¾″×4″ (2 cm×10 cm). For the purposes of the subject invention, both the first and second curable coating compositions were applied to the knife blades by electrophoretic deposition. The first curable coating composition was applied to approximately 17 microns and cured at 350° F. for 30 min. The second curable coating composition was applied to approximately 15 microns and also cured at 350° F. for 30 min. The knife blades are then subjected to a “Salt Spray” test for from 7 to 10 days such that any remaining exposed metal edges of the knife blades will have rust spots. The Salt Spray test is described in detail in ASTM B117-94. For the purposes of the subject invention, the knife blades were subjected to the Salt Spray test for 10 days. After the Salt Spray test period, the number of rust spots on the metal edges of the knife blades are visually evaluated, i.e., counted, with the assistance, if necessary, of a microscope and/or magnifying glass. A number of rust spots greater than 20 is commonly deemed unacceptable in the automotive manufacturing industry.

Importantly, as the edge corrosion resistance is improved by at least 100%, a surface roughness, Ra, of the cured multilayer coating is maintained. More specifically, as the edge corrosion resistance is improved by at least 100%, the surface roughness, Ra, of the cured multilayer coating is maintained at or below 13 μin (4.29 nm). The surface roughness, Ra, is measured with a Surtronic profilometer, particularly with a Surtronic 3+, a Surtronic 3P, or a Surtronic “Duo” profilometer, all of which are commonly relied upon in the art and are commercially available from Taylor-Hobson. This surface roughness, Ra, measurement is accepted throughout the industry to indicate an appearance, i.e., smoothness, of the second coating layer. Surface roughness, Ra, measurements at the electrocoat level that exceed 15 μin (4.95 nm) are deemed unacceptable in the automotive manufacturing industry. The smoothness of the second coating layer is important to an overall appearance of the multicoated substrate including the overall appearance of any coating layers that are subsequently applied to the second coating layer, such as basecoat and clearcoat coating layers.

When the cured multilayer coating is tested in the Edge Corrosion Test, the cured multilayer coating has less than 40 rust spots while maintaining the surface roughness at or below 13 μin (4.29 nm). Preferably, the number of rust spots is less than 30, more preferably less than 20, more preferably less than 10, more preferably less than 5, and most preferably 0. Also, the cured multilayer coating can provide 90-100% edge isolation on the substrate. The cured multilayer coating protects the edge of the substrate from corrosion and it still provides for a smoother surface to the coating.

### EXAMPLES

The following examples illustrating the making of the cured multilayer coating of the subject invention, as presented herein, are intended to illustrate and not limit the invention.

### Example 1

For Example 1, which is illustrative of the subject invention, a cathodic electrocoat bath of the first curable coating composition was prepared by adding, to a cylindrical vessel, 4000 grams of a Cathodic Black Conductive Electrocoat as the first curable coating composition. The Cathodic Black Conductive Electrocoat Was based on epoxy, bisphenol A, an amine-cap, and a blocked isocyanate cross-linking agent, and has Printex XE 2 as the electroconductive additive.

A 4×12″ test panel and a corresponding knife blade, as described above, were then electrocoated with the first curable coating composition at a 90° F. electrocoat bath temperature, at from 175 to 250 volts, and at a deposition time of from 2 to 2.5 minutes to achieve a film build of the first curable coating composition of approximately 17 microns. The coated substrates, specifically the test panel and the corresponding knife blade, were then cured at 350° F. for 30 minutes.

Next, a cathodic electrocoat bath of the second curable coating composition was prepared by adding, to a cylindrical vessel, 4000 grams of Cathoguard® 200 Series-Cathodic Grey Electrocoat as the second curable coating composition. The Cathoguard® 200 Series-Cathodic Grey Electrocoat is commercially available from BASF Corporation, Southfield, Mich., is based on epoxy, bisphenol A, an amine-cap, and a blocked isocyanate cross-linking agent, and has standard grey pigment paste incorporated therein.

The test panel and the corresponding knife blade were then electrocoated with the second curable coating composition at a 90° F. electrocoat bath temperature, at from 175 to 250 volts, and at a deposition time of from 2 to 2.5 minutes to achieve a film build of the second curable coating composition of approximately 15 microns, for a total film build of the first and second curable coating composition of approximately 32 microns. The multicoated substrates were then cured at 350° F. for 30 minutes to make the cured multilayer coating of Example 1.

### Comparative Example 1

For Comparative Example 1, a cathodic electrocoat bath of the first curable coating composition was prepared by adding, to a cylindrical vessel, 4000 grams of the Cathodic Black Conductive Electrocoat as the first curable coating composition. As described above, the Cathodic Black Conductive Electrocoat is based on epoxy, bisphenol A, an amine-cap, and a blocked isocyanate cross-linking agent, and has Printex XE 2 as the electroconductive additive.

A 4×12″ test panel and a corresponding knife blade, as described above, were then electrocoated with the first curable coating composition at a 90° F. electrocoat bath temperature, at from 175 to 250 volts, and at a deposition time of from 2 to 2.5 minutes to achieve a film build of the first curable coating composition of approximately 15 microns. The coated substrates, specifically the test panel and the corresponding knife blade, were then cured at 350° F. for 30 minutes.

### Comparative Example 2

For Comparative Example 2, a cathodic electrocoat bath of the first curable coating composition was prepared by adding, to a cylindrical vessel, 4000 grams of Cathoguard® 200 Series-Cathodic Grey Electrocoat as the first curable coating composition. As described above, the Cathoguard® 200 Series-Cathodic Grey Electrocoat is commercially available from BASF Corporation, Southfield, Mich., is based on epoxy, bisphenol A, an amine-cap, and a blocked isocyanate cross-linking agent, and has standard grey pigment paste incorporated therein.

A 4×12″ test panel and a corresponding knife blade, as described above, were then electrocoated with the first curable coating composition at a 90° F. electrocoat bath temperature, at from 175 to 250 volts, and at a deposition time of from 2 to 2.5 minutes to achieve a film build of the first curable coating composition of approximately 18 microns. The coated substrates, specifically the test panel and the corresponding knife blade, were then cured at 350° F. for 30 minutes.

### Comparative Example 3

For Comparative Example 3, a cathodic electrocoat bath of the first curable coating composition was prepared by adding, to a cylindrical vessel, 4000 grams of a high-edge performance cathodic electrocoat. Various forms of high-edge cathodic electrocoats are commercially available from BASF Corporation, Southfield, Mich. In this Example, the high-edge cathodic electrocoat is based on epoxy, bisphenol A, an amine-cap, and a blocked isocyanate cross-linking agent. The high-edge cathodic electrocoat in this Example additionally incorporates a butadiene/acrylonitrile copolymer as a flow control additive.

A 4×12″ test panel and a corresponding knife blade, as described above, were then electrocoated with the first curable coating composition at a 90° F. electrocoat bath temperature, at from 175 to 250 volts, and at a deposition time of from 2 to 2.5 minutes to achieve a film build of the first curable coating composition of approximately 20 microns. The coated substrates, specifically the test panel and the corresponding knife blade, were then cured at 350° F. for 30 minutes.

### Comparative Examples 4-7

Comparative Examples 4-7 rely on the data disclosed in U.S. Pat. No. 6,207,731 to Gam (see Column 7, lines 33-51). More specifically, Comparative Examples 4-7 correspond to Electrocoat Baths I, II, III, and IV, respectively, of the '731 patent to Gam. Electrocoat Baths I-IV have varying amounts of a flow control additive which causes the Surface Roughness, Ra, to increase.

The relative Edge Corrosion Resistance Rating and the Surface Roughness, measured as described above, for Example 1 and for Comparative Examples 1-7, are set forth below in Table 1.

TABLE 1

| | | | | Edge | |
|---|---|---|---|---|---|
| | | | Number | Corrosion | Surface |
| | | Film | Of | Resistance | Roughness |
| | Coating | Build | Rust | Rating | Ra |
| Example | Layer | (microns) | Spots | (relative) | (μin) |
| 1 | 1^{st} | 17 | | | |
| | 2^{nd} | 15 | | | |
| | Total | 32 | 1-10 | 9 | 11 |
| Comparative 1 | 1^{st} | 15 | | | |
| | 2^{nd} | 0 | | | |
| | Total | 15 | 51-60 | 4 | 22 |
| Comparative 2 | 1^{st} | 18 | | | |
| | 2^{nd} | 0 | | | |
| | Total | 18 | 61-70 | 3 | 11 |
| Comparative 3 | 1^{st} | 20 | | | |
| | 2^{nd} | 0 | | | |
| | Total | 20 | 41-50 | 5 | 17 |
| Comparative 4 | 1^{st} | 20-23 | | | |
| | 2^{nd} | 0 | | | |
| | Total | 20-23 | 100-140 | 0 | 10 |
| Comparative 5 | 1^{st} | 20-23 | | | |
| | 2^{nd} | 0 | | | |
| | Total | 20-23 | 60-80 | 2-3 | 14 |
| Comparative 6 | 1^{st} | 20-23 | | | |
| | 2^{nd} | 0 | | | |
| | Total | 20-23 | 20-40 | 6-7 | 18 |
| Comparative 7 | 1^{st} | 20-23 | | | |
| | 2^{nd} | 0 | | | |
| | Total | 20-23 | 0 | 10 | 22 |

The Number Of Rust Spots on the knife blade for each of the Examples were visually evaluated as described above. To arrive at the relative Edge Corrosion Resistance Rating, the Number Of Rust Spots were correlated to the Rating as set forth below in Table 2.

TABLE 2

| Edge Corrosion | Number | |
|---|---|---|
| Resistance Rating | Of Rust | |
| (relative) | Spots | Comment |
| 10 | 0 | Best Rating |
| 9 | 1-10 | Rust spots not connected |
| 8 | 11-20 | None |
| 7 | 21-30 | Rust spots begin to connect |
| 6 | 31-40 | None |
| 5 | 41-50 | Essentially continuous rust along |
| | | edge of blade |
| 4 | 51-60 | None |
| 3 | 61-70 | Essentially rust across entire blade |
| 2 | 71-80 | None |
| 1 | 81-90 | None |
| 0 | >90 | Worst Rating |

As Table 1 discloses, the cured multilayer coating of Example 1 has an Edge Corrosion Resistance Rating of 9 and Comparative Example 2 has a Rating of 3. Therefore, the cured multilayer coating of Example 1 provides the substrate with edge corrosion resistance that is improved by at least 100%, actually by at least 200% (9−3=6; and 6/3=2×100%=200%), as compared to Comparative Example 2, while the surface roughness, Ra, of the cured multilayer coating of Example 1 is maintained at or below 13 μin (4.29 nm), specifically at 11 μin (3.63 nm). The edge corrosion resistance is improved even more relative to Comparative Example 4, which is the only other Example that has a surface roughness, Ra, at or below 13 μin (4.29 nm). As for the remaining Comparative Examples, all of their surface roughnesses, Ra, exceed 13 μin (4.29 mn).

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A method of making a cured multilayer coating comprising
(A) applying by electrophoretic deposition a first curable coating composition to the substrate thereby establishing a coated substrate, the first curable coating composition comprising;
(i) a first compound comprising one or more active hydrogen-containing groups,
(ii) a first curing agent comprising one or more functional groups reactive with the active hydrogen-containing groups of the first compound, and
(iii) an electroconductive additive,
(B) subjecting the coated substrate to an amount of energy sufficient to cause the coated substrate to become a conductive coated substrate having an electrical conductivity of at least 130 S/cm due to the electroconductive additive, but not fully curing the coated substrate;
(C) applying a second curable coating composition to the conductive coated substrate thereby establishing a multicoated substrate, the second curable coating composition comprising;
(i) a second compound comprising one or more active hydrogen-containing groups, and
(ii) a second curing agent comprising one or more functional groups reactive with the active hydrogen-containing groups of the second compound, and
(D) subjecting the multicoated substrate to an amount of energy sufficient for cross-linking the first and second curable coating compositions to make the cured multilayer coating that provides the improved edge corrosion resistance to the substrate,
wherein a surface roughness of the cured multilayer coating is maintained at or below 13 μin, and, in an Edge Corrosion Test, the cured multilayer coating has less than 40 rust spots, wherein the Edge Corrosion Test comprises
(a) providing a knife blade measuring 2 cm×10 cm,
(b) applying the first curable coating composition on the knife blade at a thickness of about 17 μm,
(c) curing the first curable coating composition at 350° F. (176.7° C.) for 30 minutes,
(d) applying the second curable coating composition to the cured first coating composition at a thickness of about 15 μm,
(e) curing the second curable coating composition at 350° F. (176.7° C.) for 30 minutes,
(f) subjecting the knife blade to a Salt Spray Test per ASTM B117-94 for 10 days, and
(g) counting the number of rust spots on the edge of the knife blade.

2. The method of claim 1, wherein the number of rust spots is less than 30.

3. The method of claim 1, wherein the number of rust spots is less than 20.

4. The method of claim 1, wherein the number of rust spots is less than 10.

5. The method of claim 1, wherein the number of rust spots is less than 5.

6. The method of claim 1, wherein the step of (C) applying the second curable coating composition is further defined as applying by electrophoretic deposition the second curable coating composition to the conductive coated substrate.

7. The method of claim 1, wherein the step of (C) applying the second curable coating composition is further defined as spray applying the second curable coating composition to the conductive coated substrate.

8. The method of claim 1, wherein the step of (B) subjecting the coated substrate to the amount of energy sufficient to cause the coated substrate to become a conductive coated substrate is further defined as subjecting the coated substrate to an amount of energy sufficient for cross-linking of the first curable coating composition.

9. The method of claim 1, wherein the step of (B) is further defined as curing the coated substrate at a temperature of 375° F. or less for 45 minutes or less, and the step of (D) is further defined as curing the multicoated substrate at a temperature of 375° F. or less for 45 minutes or less.

10. The method of claim 1, wherein the first compound comprises an amine-modified epoxy resin.

11. The method of claim 1, wherein the first curing agent is selected from the group consisting of aminoplast resins, phenolic resins, and combinations thereof.

12. The method of claim 1, wherein the first curing agent comprises polyisocyanate resins.

13. The method of claim 1, wherein the electroconductive additive comprises electroconductive carbon black pigment present in an amount from 1.5 to 5.1 parts by weight based on 100 parts by weight of total solids of the first curable coating composition.

14. The method of claim 13, wherein the electroconductive carbon black pigment has an iodine absorption of from 870 to 930 mg/g, a specific surface area (BET/N₂) of from 850 to 1,150 m²/g, a pore volume (DBP) of from 330 to 470 ml/100 g, and an average particle size of from 25 to 35 nm.

15. The method of claim 1, wherein the first curable coating composition is free of flow control additives.

16. The method of claim 1, wherein the second curable coating composition is free of flow control additives.

17. The method of claim 15, wherein the second curable coating composition is free of flow control additives.

18. The method of claim 1 further comprising a step of providing an automotive body panel as the substrate to have the improved edge corrosion resistance.

19. The method of claim 1, wherein the first curable coating composition is an anodic electrocoat coating composition.

20. The method of claim 1, wherein the first curable coating composition is a cathodic electrocoat coating composition.

21. The method of claim 6, wherein the second curable coating composition is an anodic electrocoat coating composition.

22. The method of claim 6, wherein the second curable coating composition is a cathodic electrocoat coating composition.

23. The method of claim 1, wherein the second curable coating composition is a solventborne coating composition.

24. The method of claim 1, wherein the second curable coating composition is a waterborne coating composition.

25. The method of claim 1, wherein the second curable coating composition is a color-keyed primer surfacer coating composition.
